(19) United States
(12) Patent Application Publication
(10) Pub. No.: US 2025/0054289 A1
(43) Pub. Date: Feb. 13, 2025

(54) ELECTRONIC STATUS DETECTOR

(71) Applicant: Readiness Systems, LLC, Camas, WA (US)

(72) Inventor: Richard A. Lazar, Camas, WA (US)

(21) Appl. No.: 18/448,317

(22) Filed: Aug. 11, 2023

(51) Int. Cl. G06V 10/82

(52) U.S. Cl. CPC G06V 10/82

(57) ABSTRACT

An electronic status determination system may electronically capture digital media with respect to electronic circuitry and/or functionality of an electronic device being remotely monitored via a camera functionality of the system, and may store the captured digital media in a memory. The system may evaluate, such as in connection with one or more neural networks trained on a data set comprising the digital media, for example, to determine a status of the electronic device. The determined status of the electronic device may be communicated electronically via a communications network, such as to one or more additional computing devices, which may include a remote server device.

### FIELD

The field relates generally to electronic status detection and, more specifically, to electronic status detection of an electronic device, such as via training and/or using a trained computing network, which may include a neural or like network, for example.

### BACKGROUND

In some instances, it may be useful to analyze and/or monitor electronic circuitry and/or functionality of particular critical or like assets, such as safety equipment, backup equipment, associated infrastructure, etc. for safe or otherwise proper operation, ensuring that the assets are in an operable state and/or ready to operate as intended, once the need arises. For example, some of these assets may include Automated External Defibrillator (AED) devices, which are now common in workplaces and other public settings, but are typically used relatively infrequently. Briefly, AED devices are electronic cardiovascular devices capable of cardiac rhythm analysis and/or defibrillation, such as applying defibrillation via electrodes coupled to a person's chest after electronically detecting the presence of ventricular fibrillation or ventricular tachycardia. Assets such as AED devices may have an increased risk of being forgotten or falling into disrepair such that they are not ready for use if their operational readiness is not assessed and/or monitored.

Analysis and/or monitoring of electronic circuitry and/or functionality of such assets can include analyzing and/or monitoring the power level of a battery, AED's operating state, electrodes condition, defibrillation features readiness, scheduled maintenance, and/or other aspects of the asset. Some critical assets may also be subject to increased regulatory requirements and/or or manufacturer standards, such as AED devices that are regulated by the U.S. Food and Drug Administration (FDA) and state AED laws. AED devices are typically designed to be stored in enclosures, such as wall-mounted cabinets with glass or like doors or windows so that they are visible and easier to find in emergencies, but somewhat protected while not in use, or in hard-plastic portable monitoring cases. Because a deployed AED device must be ready to treat sudden cardiac arrest (SCA) when needed, such as by delivering a measured electric shock to a person experiencing a cardiac event to restore the heart's natural rhythm, the AED device must be ready to function properly at all times.

AEDs may also include one or more visible electronic indicators, such as one or more light-emitting diodes (LEDs), a liquid crystal display (LCD), or other visible indicators that serve to make aware of the devices condition, detected faults, errors, and other such data. For example, some LED displays may indicate a change in state by being on or off, changing colors, flashing, or other such distinguishable display characteristics, often further indicated by text accompanying the LED that describes the meaning of various displayed LED characteristics. LCDs often convey more information, such as displaying an icon or picture representing a certain condition or readiness state, displaying an error message in text, and the like.

Typically, periodic physical inspections and/or replacement of items such as batteries, electrodes, etc. that have limited shelf lives may help with ensuring a proper operation of AED devices. However, these or like physical inspections typically do not involve electronic circuitry and/or functionality analyses and/or assessments, meaning that it is not uncommon for AED devices that are displaying error messages or other indications of potential problems with their electronic circuitry and/or functionality to go unnoticed, and corrective actions are often not performed. As indicated above, this puts the usability of AED devices at risk, and possibly puts the life of a person experiencing a cardiac event at risk as well. Similar problems may exist for many other critical assets, demonstrating a need for more efficient and/or more reliable analysis and/or monitoring of electronic circuitry and/or functionality of such assets.

### BRIEF DESCRIPTION OF THE DRAWINGS

FIG. 1 is a block diagram showing an electronic status detection system in an operating environment, consistent with an example embodiment.

FIG. 2 shows an Automated External Defibrillator (AED) and an electronic status detection system in enclosures, consistent with example embodiments.

FIG. 3 is a block diagram of an AED and an electronic status monitoring system, consistent with example embodiments.

FIG. 4 is a flowchart of a process of performing an electronic status determination, consistent with an example embodiment.

FIG. 5 is a flowchart of a method of operating a camera assembly of an electronic status monitoring system, consistent with an example embodiment.

FIG. 6 is a flowchart of an LCD imaging thread, consistent with an example embodiment.

FIG. 7A is a flowchart of an LED imaging thread, consistent with an example embodiment.

FIG. 7B is a flowchart of a JPEG framestream thread, consistent with an example embodiment.

FIG. 7C is a flowchart of a frame receive thread, consistent with an example embodiment.

FIG. 7D is a flowchart of an inference process, consistent with an example embodiment.

FIG. 8 is a flowchart of a method of operating an electronic status detection system, consistent with an example embodiment.

FIG. 9 is a schematic diagram of a neural network, consistent with an example embodiment.

FIG. 10 shows a convolutional neural network as may be used to determine an electronic device status in some example embodiments.

FIG. 11 shows a computing environment in which one or more electronic status monitoring processes may be implemented, consistent with an example embodiment.

The claims provided in this application are not limited by the examples provided in the specification or by the drawings, but may be better understood by reference to the examples provided in the following detailed description and in the drawings.

### DETAILED DESCRIPTION

In the following detailed description of example embodiments, reference is made to specific example embodiments by way of drawings and illustrations. These examples are described in sufficient detail to enable those skilled in the art to practice what is described, and serve to illustrate how elements of these examples may be applied to various purposes or embodiments. Other embodiments exist, and logical, mechanical, electrical, and other changes may be made.

Features or limitations of various embodiments described herein, however important to the example embodiments in which they are incorporated, do not limit other embodiments, and any reference to the elements, operation, and application of the examples serve only to aid in understanding these example embodiments. Features or elements shown in various examples described herein can be combined in ways other than shown in the examples, and any such combinations is explicitly contemplated to be within the scope of the examples presented here. The following detailed description does not, therefore, limit the scope of what is claimed.

As was indicated, critical assets, such as safety equipment, backup devices, etc. and/or associated critical infrastructure may often be inspected to ensure that they remain in good working condition, are able to perform their intended functions if needed, etc. Conventionally, these physical inspections, such as to ensure good physical condition, and/or functional verification may involve checking an asset by operating it or via a built-in self-test, and observing how the performs, checking for lights, sounds, etc. For Automated External Defibrillator devices or AEDs, physical inspections may be performed in a similar manner, and may involve operating the devices while checking a visible status indicator, such as a colored or flashing Light-Emitting Diode (LED), or icons, images and/or text on a Liquid Crystal Display (LCD) screen, or the like.

As alluded to previously, these or like physical inspections may be rather limiting. An AED may display a green LED, for example, for normal self-test or operation and a healthy battery, a red LED, for example, for a battery that needs replacement, a flashing LED, for example, to indicate an error condition or other problem. As another example, during testing and/or operation, an AED may use an LCD screen to display a charge status and/or other condition of the battery, icons to display the state or configuration of the AED, text error messages describing any errors, malfunctions, or expired components such as electrodes, or the like. Because AED devices are relatively rarely used for defibrillation, it is not uncommon for them to fall into disrepair, such that they are not able to function properly if needed, as was also indicated above. Although manufacturer guidelines and/or safety regulations may call for periodic physical inspections to ensure that AEDs remain operational, such guidelines and/or regulations are often overlooked once an AED is deployed or placed in service.

Thus, since AED devices are used to perform cardiac rhythm analysis and/or defibrillation at a time of an emergency cardiac event, such as ventricular fibrillation or ventricular tachycardia, for example, there is insufficient time to replace batteries, obtain new electrodes, or perform other repairs once an immediate need for the AED device arises. As such, continual analysis and/or maintenance of critical assets, such as AEDs, for example, including associated electronic circuitry and/or functionality may, therefore, be critical or otherwise useful, so as to ensure that such devices are able to perform as intended once the need arises.

Accordingly, as described below, one or more example implementations are presented herein that may be used, in whole or in part, to address and/or solve these or like issues or problems, such as by providing one ore more approaches and/or techniques for electronic status detection of a particular device having an associated electronic circuitry and/or functionality, such as an AED. As will be seen, these or like approaches and/or techniques may include training and/or deploying a trained computing network, which may include a neural or like network, for example, to facilitate and/or support analysis and/or monitoring of electronic circuitry and/or functionality of these or like devices. As also described below, in some instances, these or like approaches and/or techniques may include utilizing an electronic monitoring system leveraging one or more artificial intelligence applications or processes, which may include one or more machine learning applications and/or processes, for example. These or like applications and/or processes may substantially continually assess or evaluate computer circuitry and/or functionality of an AED so as to determine a state of the device. As will also be seen, in some instances, these or like machine learning applications and/or processes may be implemented, at least in part, in connection with processing digital media obtained via one or more visible electronic indicators. Subsequently, a determine state may be communicated electronically to one or more other computing devices, such as via a communication network, for example.

As alluded to previously, a visible electronic indicator in some examples may comprise an image and/or text rendered on a Liquid Crystal Display (LCD) image and/or text, such as an icon indicating a charge state or condition of a battery, an error message presented as text that describes an error, or the like. In other examples, the visible electronic indicator may comprise one or more Light-Emitting Diodes (LEDs), which use characteristics such as color, on/off state, blinking, etc. to indicate a condition and/or state of an AED device. In some instances, an electronic status detector may include, for example, a remote monitoring device utilizing a built-in and/or associated imaging sensor, such as a digital camera, as one example, to capture one or more digital images of a visible electronic indicator, such as by taking pictures or video of the visible electronic indicator. At times, a particular learning process, such as a neural network, for example, may be employed, in whole or in part, to capture digital media representing LED or LCD images and may process one or more images to evaluate and/or determine a state of a visible electronic indicator, and therefore a state or condition of an AED device. It should be noted that the terms “AED” and “AED device” may be used interchangeably herein.

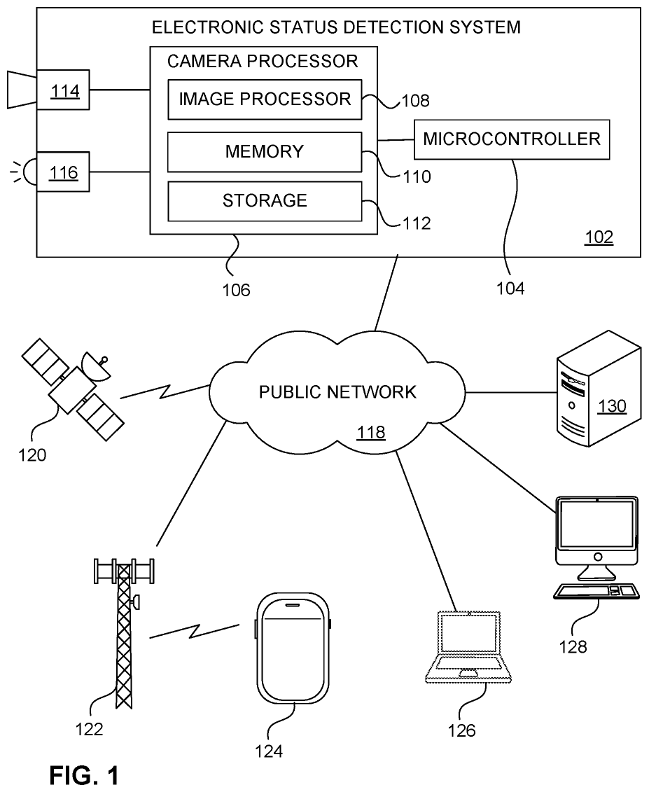

FIG. 1 is a block diagram showing an electronic status detection system in an operating environment, consistent with an example embodiment. An electronic status detection system 102 may include a microcontroller 104 and a camera processor 106, each operable to process computer instructions to perform various tasks or functions. The camera processor may include elements such as an image processor 108, a memory 110, and a storage 112. Storage 112 may be used to store computer instructions to implement various functions such as artificial intelligence, including machine learning by use of a trained neural network, used to capture images and detect the status of one or more electronic devices. The camera processor 106 may be coupled to a digital camera 114, and to a light 116, which may be operable to take a picture or video of an electronic device that is being monitored and illuminate the electronic device. It should also be noted that the terms “electronic status detection system” and “electronic status detector” may be used interchangeably herein.

The electronic status detection system 102 is coupled to a public network 118, such as a cellular telephone network, the Internet, and/or another network, over which it may communicate with other networked devices. In a more detailed example, The public network 118 is in some examples coupled to one or more other computerized devices via a satellite 120, a cellular telephone system 122, or other network. The electronic status detection system may use the network to communicate with electronic devices such as a smart phone 124, a mobile computer such as laptop computer 126, a desktop computer 128, and/or a server 130.

In a more detailed example, the electronic status detection system 102's camera processor controls the camera 114 and the light 116 to illuminate and capture digital images and/or video of an electronic device being monitored, such as an Automated External Defibrillator (AED). The electronic status detection system's camera and light are positioned such that they can digitally image and illuminate at least a portion of the electronic device having a visible status indicator, such as a sold or flashing Light-Emitting Diode (LED) that in a further example may have varying color, a display or screen such as a Liquid Crystal Display (LCD) screen or Organic Light-Emitting Diode display (OLED display), or other display that may display text, graphics, or other such visual indications of status of the AED.

Visible status indicators on an electronic device such as an AED may include a light such as an LED being in an on or off state, being a different color, flashing (or flashing at different rates), or exhibiting states such as these in various combinations. Other visible status indicators may include an electronic display, such as a Liquid Crystal Display (LCD), Organic Light-Emitting diode (OLED) display, or other electronic display that displays an icon, text, or other visible representation of status of the AED. For example, a battery icon may have several internal segments that progressively fill an outline image of the battery to indicate the state of charge of a battery internal to the AED. In another example, an error icon, code, or text message may be displayed on the electronic display, such as indicating an operational error or malfunction, time-based expiration of a component such as a battery or electrode pads, or other such status indicator.

The light 116 is operable to illuminate the electronic device, such as an AED, when illuminating the device to obtain a clear image is deemed beneficial such as when the camera 114 detects a low enough light condition that additional illumination would be of benefit in detecting a visible status indicator on the electronic device. For example, an AED in a cabinet in a hallway may be sufficiently illuminated during the business day to obtain a clear picture of the AED, including any visible status indicators, but may not be visible outside of business hours when hallway lighting is turned off. Similarly, a light may be helpful in illuminating a visible status indicator that is not self-illuminating, such as a liquid crystal display (LCD) that does not have a backlight, but may not be needed for other visible status indicators such as LED lights or backlit displays such as backlit LCD displays. In a further example, the electronic status detection system 102 may be operable to determine the type of electronic device being monitored, such as by taking a picture of the device using the camera 114 or by being programmed or configured with a manufacturer, model, or other identifying information of the AED or other electronic device. This configuration information may be used to determine whether illumination is needed for the camera to detect specific visible status indicators associated with the particular known device.

One or more images from the camera may be stored in memory 110 or in another volatile memory, and in some examples may be stored in storage 112 or in another nonvolatile memory. Program instructions may also be stored in storage 112 and loaded into memory 110 for execution on image processor 108, including program instructions for capturing images, image sequences, and/or video, and for evaluating the images such as by using a trained neural network or other artificial intelligence to determine the state of one or more visible status indicators in the captured image or video.

In a more detailed example, microcontroller 104 instructs the camera processor 106 to capture one or more images of an electronic device such as an AED, and the camera processor uses image processor 108 to selectively illuminate the AED using light 116 and capture the one or more requested images using camera 114. The captured images are stored in memory 110, and are written to storage 112 such as a flash memory or hard disk drive. The images may be filtered or otherwise processed using image processor 108, such as to improve or enhance the quality of the captured image or images. When image processor 108 sees the one or more images stored in an image queue, such as in memory 110 or in storage 112, the image processor may identify a state of the AED or other electronic device being monitored by detecting one or more visible status indicators in the image of the electronic device, and may report the status to microcontroller 104. The microcontroller 104 may then report the status such as via a public network 118 to one or more other computerized systems such as a server 130 operable to track the status of one or more remote electronic devices.

Communication via public network 118 in some examples may use wireless networking technology such as Wi-Fi or Bluetooth, wired networking such as Ethernet, or cellular technology such as LTE or various other cellular data series such as enhanced machine-type communication (eMTC) using an eMTC category M1 cellular radio device (Cat-M1). Other cellular network or similar technologies may be used in other examples, such as enhanced machine-type communication (eMTC), eMTC category M1 (Cat-M1), Narrowband Internet of Things (NB-IoT), LTE, and 5G. In other examples, satellite communication using satellite 120 may be employed, such as for monitoring remote electronic devices in environments where cellular service is not available. In a more detailed example, when microcontroller 104 receives a status indication for an electronic device being monitored (such as an AED) from camera processor 106, it sends the status using one or more network communications links, such as a wireless link, a wired link, or a combination to at least one other device such as a server 130. Server 130 may further notify an end user such as by sending an alert to a computerized device such as smartphone 124, portable computer 126, or personal computer 128.

The electronic status detection system of FIG. 1 may perform analysis of the image in the camera processor, such as using a trained neural network or other artificial intelligence executing on the camera processor's image processor 108 to make a status determination. It may also use microcontroller 104 to perform a status determination in some examples, such as by using a trained neural network to evaluate one or more images of the AED or other electronic device being monitored, or use a remote server 130 to make such a status determination. In a more detailed example, image processor 108 is operable to execute a neural network, such as a convolutional neural network, that has been trained to recognize one or more Light-Emitting Diode (LED) status indicators on the AED or other electronic device. For example, an AED having a green LED indicating a normal operating state and a red LED indicating an error position can be effectively monitored by a relatively simple convolutional neural network trained to evaluate a medium-resolution image (such as 640×640 pixels) for the presence of either a red or green LED. If an AED make or model having an LCD display instead of LED status indicators is being monitored, one or more higher resolution images may instead be forwarded to a remote server 130 hosting a more complex convolutional neural network operable to read an icon, error message, or other visible status indicator from the image of the AED or other electronic device being monitored. In a further example, the light 116 is illuminated when useful to capture an image of an LCD display that is not backlit, but is off or is illuminated to a lesser degree when capturing an image of an electronic device such as an AED with a self-lit visible status indicator such as a colored LED.

The type of electronic device or AED being monitored in some examples may be configured in the microcontroller 104 or the camera processor 106, and may be used to determine the type of image taken, whether illumination is used, and how the image is processed to determine the state of the AED. In other examples, one or more images taken by camera 114 may be used to identify the AED being monitored, such that the identification may be used to configure subsequent images, illumination, and processing of the captured images to determine the AED's status.

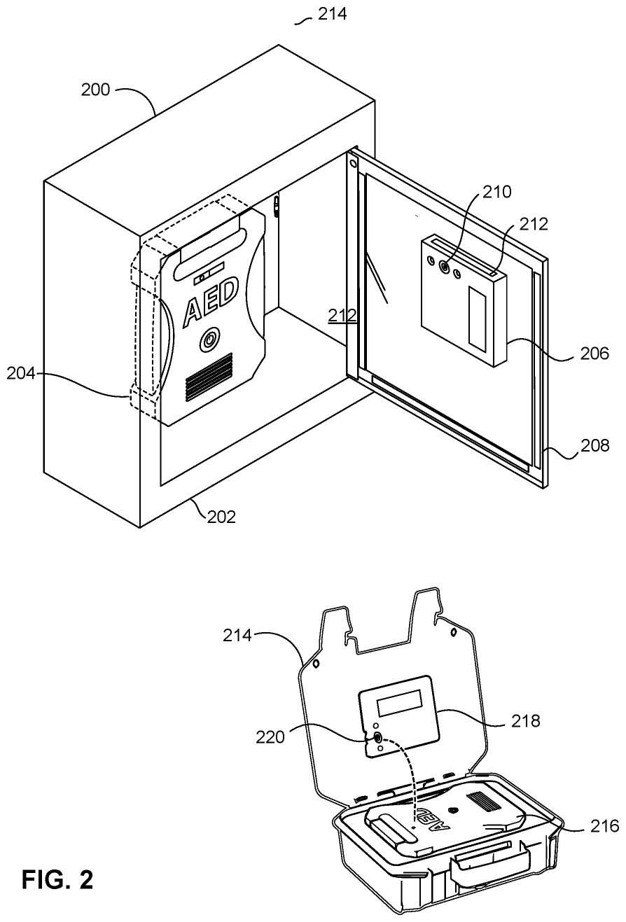

The AED in some examples may be contained in a cabinet, such as a metal cabinet having a door with a glass window providing visibility of the AED from the cabinet's exterior. In another example, the AED may be stored in a portable case that includes an electronic status detection system. FIG. 2 shows an Automated External Defibrillator (AED) and an electronic status detection system in enclosures, consistent with example embodiments. The AED, cabinet, portable AED case, and electronic status detection system are shown generally at 200. As shown here, a cabinet 202 may be metal, wood, plastic, or any other suitable material, and contains an Automated External Defibrillator (AED) 204 and the electronic status detection system 206. The cabinet and case perform various functions such as protecting the AED from the environment, ensuring the AED remains in the designated location, and may perform other such functions. The cabinet in this example includes a door 208 having a large glass window, such that an observer external to the cabinet can see that the cabinet 202 contains an AED 204.

The electronic status detection system comprises a camera processor coupled to a camera 210, which may include one or more lights attached to or associated with the camera and/or camera processor. The camera in this example may be a wide-angle camera, and in another example may be attached to the door 208 of the AED cabinet 202 in a location where it can see and can take images of one or more visible status indicators on the AED 204 such as an LED, an LCD display, or other such visible status indicator. One or more lights may be further operable to illuminate the AED 204, such as to illuminate an LCD display that is not backlit so that the camera 210 can effectively capture a digital image of the LCD display or other visible status indicator.

The camera processor may be coupled to a microcontroller, which may perform various functions such as controlling the camera processor, communicating with external devices such as through antenna 212, and performing other such functions to manage the electronic status detection process. Antenna 214 may be either external to the electronic status detection system or integrated into the electronic status detection system as shown in FIG. 2. The antenna and associated electronics may be used to communicate with remote system such as described in the examples of FIG. 1, including cellular towers 122, satellites 120, and other such wireless services. In other examples, antenna 212 accesses local, metropolitan, or personal area wireless communications, such as WiFi networks, Bluetooth, and/or WiMax wireless networks. Any of these wireless network types may enable the microcontroller to communicate with one or more remote electronic devices such as a server smartphone 124 via private and/or public computerized device networks such as local area networks, cellular networks, the Internet, and the like.

In another example, a portable AED case 214 encloses an AED 216 and an electronic status detection system 218, which again may comprise various elements of FIG. 1 such as a camera 220, one or more lights, a camera processor, a microcontroller, an antenna, and the like. The electronic status detection system 218 in this example is mounted to a lid or cover of the portable AED case, and in a further example the lid or the portable AED case 214 are configured to receive the electronic status detection system 218. In a more detailed example, the portable AED case 214 and/or the electronic status detection system 218 are configured such that a camera 220 of the electronic status detection system is oriented toward a display, LED, or other status indicator of AED 216. The portable AED case 214 may be formed of various materials in various examples, including plastic, metal, or other such suitable materials, and in some examples further comprises padding, suspension, or other material configured to protect the AED 216 within the portable AED case 214 from damage in the event of impact.

The cabinet 202 or portable AED case 214 may be placed in various environments in a business setting, such as in a hallway, a closet, a break room or lunchroom, a workshop or laboratory, a vehicle, or any other environment where the AED is available for use when an emergency strikes. Different environments may present different challenges to keeping the AED safe and to electronically determining the status of the AED, such as where the environment is in a dark closet or hallway or vehicle and needs illumination from a light for camera 210 or camera 220 to properly image some visible status indicators. Other environments such as a laboratory setting, a commercial kitchen, or a manufacturing facility may be dirty and require a cabinet such as cabinet 202 or portable AED case 214 to protect the AED, or may have cleanliness requirements such as in a commercial kitchen or laboratory where cabinet 202 or portable AED case 214 serve to keep the AED and the components of the electronic status detection system clean and dry. In still other environments, such as an office environment, the AED may be placed on a closet shelf with no cabinet, where the electronic status detection system is not mounted to a cabinet but is mounted to the closet, to the portable monitoring case, to the AED, or in another suitable way to monitor the AED or other electronic device. In mobile environments, the AED may be placed in a hard plastic monitoring case to protect it during vehicle operations and from the elements and there is a need to provide a suitable way of monitoring such AEDs.

Environments such as these may vary in the lighting, cleanliness, wireless or wired network communication access, and other environmental conditions, which in turn may be reflected in variations in the configuration of cabinet 202, portable AED case 214, or the AED's storage environment. For an AED mounted outside, such as at a theme park, the cabinet may have a higher degree of water resistance throughout the cabinet, ultraviolet light protection through the glass in door 206, and a camera with a wider range of acceptable light conditions than an AED mounted in an office location or portable monitoring case. The outdoor location may also lend itself well to communication via cellular communication protocols such as LTE, 5G, or eMTC Cat-M1 communication, while an office-based AED device and cabinet may be more readily able to use existing WiFi where strong coverage is provided throughout the office environment. Various elements shown in FIG. 2, such as the cameras 210 and 220, the cabinet 202, the portable AED case 214, and other such elements may therefore vary in different applications, such as in different physical operating environments or network environments.

In some examples, the microcontroller and the camera processor may not be combined in a single controller, but may have their functions distributed among more or different elements. In the example shown in FIG. 2, a single board computer with a single processor and a cellular radio module may take the place of both the microcontroller and the camera processor, and may control the camera 210 or 220, associated lighting, antenna 212, and/or other features such as a door open switch or sensor operable to detect when the door 208 to cabinet 202 or portable monitoring case is open (such as to trigger a status check, to detect the presence of the AED, to illuminate the cabinet or case, or perform another such function). Such a switch may in various embodiments be a physical switch, an infrared or magnetic detection element, or any other device operable to detect whether door or case 206 is open or closed. Although camera 210/220, the electronic status detection system 206/218, and related components are shown here as being internal to cabinet 202 or case 214, in other examples one or more of these elements may be external to the cabinet 202 or case 214, or may be otherwise positioned near the AED such as in an office environment when no cabinet is used or in a portable monitoring case.

Detection of one or more visible status indicators of the AED or other electronic device may rely at least partially in some examples on knowledge of the electronic device being monitored and what status indicators the electronic device employs. For example, some models or brands of AED may employ one or more red LEDs to indicate and error condition, and one or more green LEDs to indicate normal operation. The red and green LEDs may be in the same physical package, such that the color or a single LED package appears to change from red to green based on a change in status of the AED. Some examples may employ a liquid crystal display, an OLED display, an LED segment display, a vacuum fluorescent display (VFD), or another type of visible status indicator that may or may not be self-illuminating. Knowledge of the type of visible status indicator on the AED or other electronic device may enable the electronic status detection system to look for the appropriate visible status indicator, to selectively apply illumination when the visible status indicator is not self-illuminating, and to perform other such functions. Determination of the type of AED or other electronic device being monitored, and the associated visible status indicators, may be programmed into the electronic status detection system in some examples, such as by storing it in microcontroller 104 or in the camera processor 108's storage 112. In other examples, the identity of the AED or other electronic device may be determined by taking an image of the device using camera 114 and recognizing one or more identifying characteristics of the device, such a model number or manufacturer name, a physical configuration of the AED or other electronic device, or the like. Once an AED or other electronic device is recognized through such a process, the identity of the device may be stored for future use in detecting one or more visible status indicators associated with the identified device, or the device may be identified each time an image is taken such as identifying the device before or as a part of identifying the one or more visible status indicators in one or more images captured with camera 114.

In a further example, the AED's operation when taking an image and determining the status of the AED or other electronic device may be based on such prior knowledge of the type (such as brand, model, etc.) of device being monitored, such as to use a light to take images when he visible status indicator is not self-illuminating, to detect color of an LED when the color is known to be indicative of the AED status, or to take multiple images over time when the AED or other electronic device may employ flashing or alternating LEDs or other time-varying indicators of status. In another example, the electronic status detection system may vary the neural network or other machine learning tool applied to evaluate the image for a visible status indicator, such as using a different neural network to look for different-colored LEDs than may be used to recognize and interpret text or icons on an LCD or OLED display. In a further example, the one or more different neural networks or other machine learning tools used to evaluate images may be located in different elements of the electronic status detection system, such as using the microcontroller 104 or the camera processor 106 to employ simple neural networks that process relatively low resolution images, such as to look for an LED having a certain color, while more complex status recognition tasks such as using a neural network to evaluate an image for the presence of certain text, icons, or other more sophisticated visible status indicators may be performed in, but is not limited to, a remote server such as server 130 of FIG. 1.

The neural network or other artificial intelligence or machine learning tool used in various examples to evaluate one or more pictures for visual status indicators of the AED's status may be trained on a data set of images of AEDs (or other electronic devices) having the same visual status indicators along with associated designations of the AED's known status. In a more detailed example, a convolutional neural network is trained to output a status selected from a plurality of possible statuses based on the image received as an input, such as a colored LED, text, icon, or other visible status indicator present in the image. The training process in some examples may comprise using different neural networks for different types of devices, such as a first neural network for LED color recognition and potentially more complex neural network for recognizing text, graphic icons, and other such visible status indicators. The trained neural networks may be refined in a further example by collecting falsely-identified status samples and introducing them into the training set, thereby improving the neural network's ability to identify even the most difficult visual status indicator image examples.

The neural network (or other machine learning or artificial intelligence tool) may also be trained on a single type of AED or other electronic device in some examples, such as where configuring the known AED or other electronic device in the electronic status detection system includes providing a neural network specifically trained to identify visual status indicators of the known AED or other electronic device. In other examples, neural networks may be trained to identify visible status indicators in families of similar devices, such as devices within the same family that use similar but slightly different status indicators such as similar LED color schemes, similar text displays, or similar icons. In more complex examples, a neural network or other machine learning system may be trained on a variety of different types of AEDs or other electronic devices with different visible status indicators, and may learn to recognize the different types of visible status indicators as well as the status of each different visible status indicator type. In some examples, such a neural network may be more complex or computationally inefficient than a neural network trained to recognize a limited scope of visible status indicators, and so may not be desirable for applications where battery life, limited computational resources, or other constraints limit its usefulness.

The AED cabinet 202 or portable AED case 214 in a further example comprises additional functionality located within the cabinet or case and/or as part of the electronic status detection system, such as a GPS receiver operable to determine the physical location of the cabinet or case. In other examples, similar location technologies such as GLONASS may be used to determine location, or other information such as the IP address of a WiFi connection, the cellular network connection, or other such information can be used to determine or estimate the location of the AED cabinet or case. In a more detailed example, methods such as time-of-flight to one or more cellular telephone towers can be used to triangulate the location of the AED cabinet. In another example, relative signal strength observed by one or more nearby cellular telephone towers may be used to determine approximate location. In other examples, any other suitable location technology can be used to similarly determine the location of the AED cabinet or case, the AED, or another element of the electronic status detection system, such that the location can be reported back to a server 130, a user of a monitoring application on a smart phone 124 or computer 128, or otherwise report its location (such as with a status report).

Visible status indicators in various examples comprise electrical, electro-optical, electromechanical, or other such indicators of the status of an AED or other electronic device, such as may be detected by a camera 210. Various embodiments may include one or more lights such as Light-Emitting Diodes (LEDs), including lights that flash on and off, that are different colors, or that have other such visibly distinct characteristics. Other examples include displays that can vary in the icons, text, or other image they display, such as a Liquid Crystal Display that may display various text messages, a battery icon having different segments showing a state or degree of charge, of other such visible status indicators. The display in various examples may be backlit, such that the display produces its own light and is visible in a dark environment, but in other examples may not be lit and may rely upon environmental light such as a light associated with camera 210/220 to illuminate the display for digital imaging via the camera. Still other examples will use other technology to produce a visible status indicator, such as a Vacuum Fluorescent Display (VFD), an Organic Light Emitting Diode (OLED) display, or electromechanical indicators. Electromechanical indicators may include moving or opening/closing a window to display a desired message, color, or the like, or any other type of visible status indicator that can be electromechanically controlled by the AED or other electronic device being monitored.

The visible status indicator may indicate one or more status conditions of the AED or other electronic device, such as an operational state, a self-test state, a battery charge state, an electrode state, or other state of the device. In a further example, the visible status indicator may indicate that a service interval has been reached or is about to be reached, may indicate expiration or replacement of one or more components, or may indicate another such service condition. In a more detailed example, an LCD display shows a battery icon that is flashing on and off, indicating that the battery needs to be replaced, and a text message indicating that electrode gel pads are nearing their expiration date and are due for replacement. These visible status indicators may be seen via camera 210, and the corresponding AED status may be relayed to a remote server 130, an end user such as a user of smartphone 124 or computer 128, or otherwise communicated to a user or computerized system.

Example such as these illustrate how monitoring assets such as an AED may include simple tasks such as monitoring the charge state of a battery to more complex tasks such as monitoring the operating state, condition, readiness, maintenance, or other aspects of the asset. Because some AEDs and other electronic devices that are regulated by the U.S. Food and Drug Administration (FDA) and state AED laws, and are typically designed to be stored in enclosures such as wall-mounted cabinets with glass doors so that they are visible, or in portable AED monitoring cases, a means of monitoring the AED's visible status indicators in such an environment is desirable to ensure the AED device is ready to treat sudden cardiac arrest when needed.

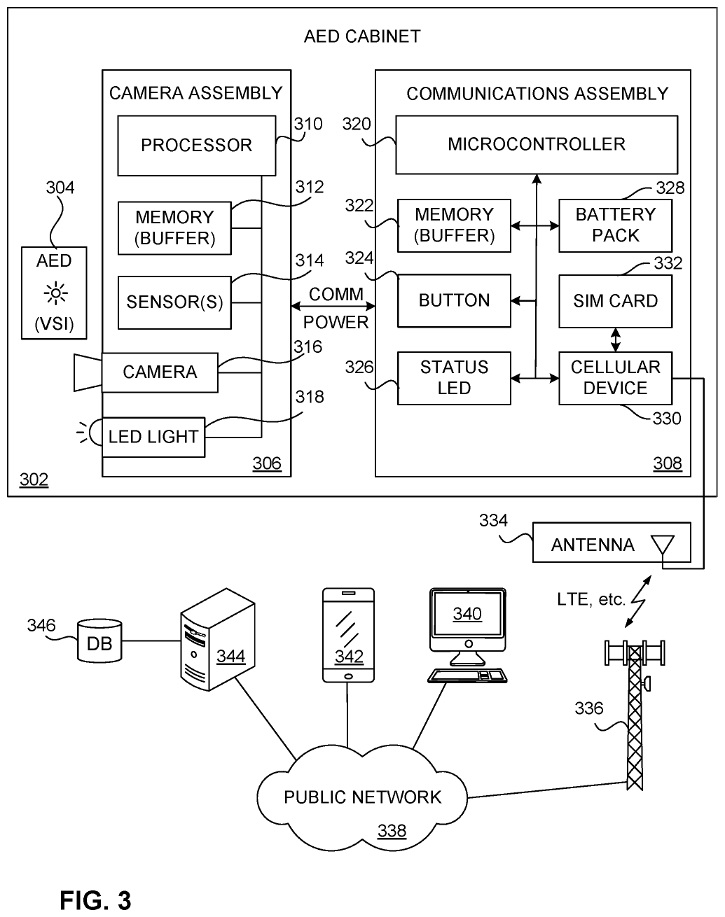

FIG. 3 is a more detailed block diagram of an AED and an electronic status monitoring system, consistent with an example embodiments. Here, an AED cabinet 302 (such as is shown at 202 or 214 of FIG. 2) includes an AED 304 having one or more visible status indicators (VSIs), a camera assembly 306, and a communications assembly 308. The camera assembly 306 may correspond approximately to the camera processor 210/220 of FIG. 2, and the communications assembly may comprise a part of electronic monitoring system 206/218 of FIG. 2. Camera assembly 306 may include a processor 310, which is operable to execute computer instructions to perform various functions such as those described in the examples presented herein. A memory 312 may store computer instructions during execution and may also serves as a buffer for captured digital images. One or more sensors 314 may include sensors such as a door sensor or other sensor. Camera 316 may be oriented or configured to take an image of AED 304, and LED light 318 may be configured to illuminate at least part of AED 304 for imaging via camera 316.

Communications assembly 308 may be coupled to camera assembly 306, such as to communicate between the camera assembly and the communications assembly or to share power between the camera assembly and the communications assembly. The communications assembly may comprise a microcontroller 320, operable to execute one or more computer instructions to perform various functions such as those described in the examples presented herein. A button 334 may be provided to perform functions such as initiating a test, activation, reset, or other such function for the electronic status detection system. A status LED 326 may indicate a readiness state, operating state, or other condition of the communications assembly and/or the electronic asset monitoring system, as may be determined by microcontroller 320. Battery pack 328 may provide power to the communications assembly, camera assembly, and/or other components of the electronic monitoring system. The battery pack may be the only source of power for these elements, or may be a backup to line power such as provided via an AC outlet or other power source. A cellular device 330 and Subscriber Identity Module (SIM) card 332 work together to communicate information from the electronic monitoring system, such as a determined status of the AED and/or one or more images of the AED via an antenna 334 to a remote electronic device via cellular network tower 336, public network 338, and/or other communications means. The determined status of the AED, one or more images of the AED, and/or other such information may be communicated to end user devices such as computer 340, a smartphone 342, or a server 344 that may store such information in a database 346 as a record of the AED's status for later retrieval.

In operation, an electronic device status monitoring event is initiated, such as based on a certain amount of time elapsing since the last such event, remote or user triggering of the event, manual triggering of the event such as a user pushing button 324, or another triggering event. In a more detailed example, the electronic status monitoring system is configured to perform a daily, weekly, or monthly status test, and if status results are not received at a server 344, the remote server 344 will alert users to initiate a status test. In another example, remote server 344 may initiate a remote status test based on one or more other events, such as upon detecting that the door to the AED cabinet or portable AED monitoring case 302 has been opened (which may be determined via camera 316), upon detecting a change in geographic location, or upon another event.

Microcontroller 320 may control operation of the status test event, sending a command to camera assembly 306's processor 310 to capture or more images of the AED 304 and determine its status. In a more detailed example, processor 310 determines whether the AED installed in cabinet or case 302 uses LEDs, LCD or other display, or other visible status indicators, and takes one or more corresponding actions. For LED visible status indicators, the camera 316 takes one or more digital images of AED 304 and stores them in memory 312. An image processing thread executing on processor 310, such as a convolutional neural network configured to recognize one or more visible status indicators (such as colored, blinking, or other lights) on AED 304 processes the image and makes a status determination. The status determination is returned to microcontroller 320, which stores it in memory and communicates it to one or more remote devices via cellular device 330.

In another such example, AED may employ an LCD display or other visible status indicator requiring more complex status determination. Microcontroller 320 may again control operation of the status test event, sending a command to camera assembly 306's processor 310 to capture or more images of the AED 304 and determine its status. Processor 310 may determine that the AED installed in cabinet or case 302 employs an LCD or another graphic and/or text display, and light LED light 318 to illuminate the display. The camera 316 may take one or more digital images of AED 304, store them in memory 312, and forward the images to microcontroller 320 to be stored in its memory 322. Cellular device 330 may then be employed to send the one or more images to a remote server 344. An image processing thread executing on remote server 344, such as a convolutional neural network configured to recognize one or more visible status indicators (such as text, graphic icons, or other such visible status indicators) on AED 304 processes the image and makes a status determination. The status determination is then stored in database 346.

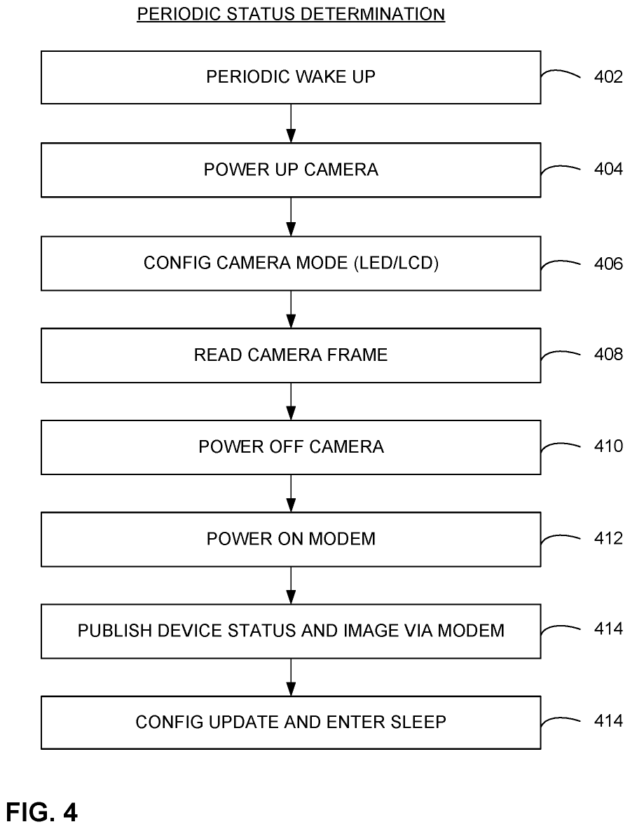

FIG. 4 is a flowchart of a method of performing a periodic electronic status determination, consistent with an example embodiment. At 402, a system clock, remote trigger, or other method may be used to initiate a periodic status determination by waking up the electronic status detection system and initiating a status check. The camera may be similarly powered up at 404, and a camera may be configured at 406 based on the type of visible status indicator the AED or other device employs. In a more detailed example, a self-lit LED visible status indicator may be associated with determining the status of the AED or other electronic device using a neural network or other artificial intelligence tools in the electronic status monitoring system, while more complex visible status indicators such as an LED showing graphics and/or text may be associated with using a light to illuminate the AED and adjusting the camera exposure accordingly, and performing status determination using the image on a remote server or other device hosting a more complex neural network or other artificial intelligence.

A camera frame may be read at 408, which in a further example may comprise capturing a sequence of digital images or video of the AED or other electronic device, such as where the AED employs a flashing LED or other lights as a visible status indicator. Once the digital image or images are captured, the camera is powered off at 410, and a modem, such as a cellular telephone network modem (e.g., LTE, 5G, eMTC Cat-M1, or the like) is powered on. The device states and/or image taken via the camera are published to a server via the modem at 414, and the electronic status detection system updates its configuration (such as the next time to wake and perform a periodic status determination) and enters a sleep state at 414 to conserve power.

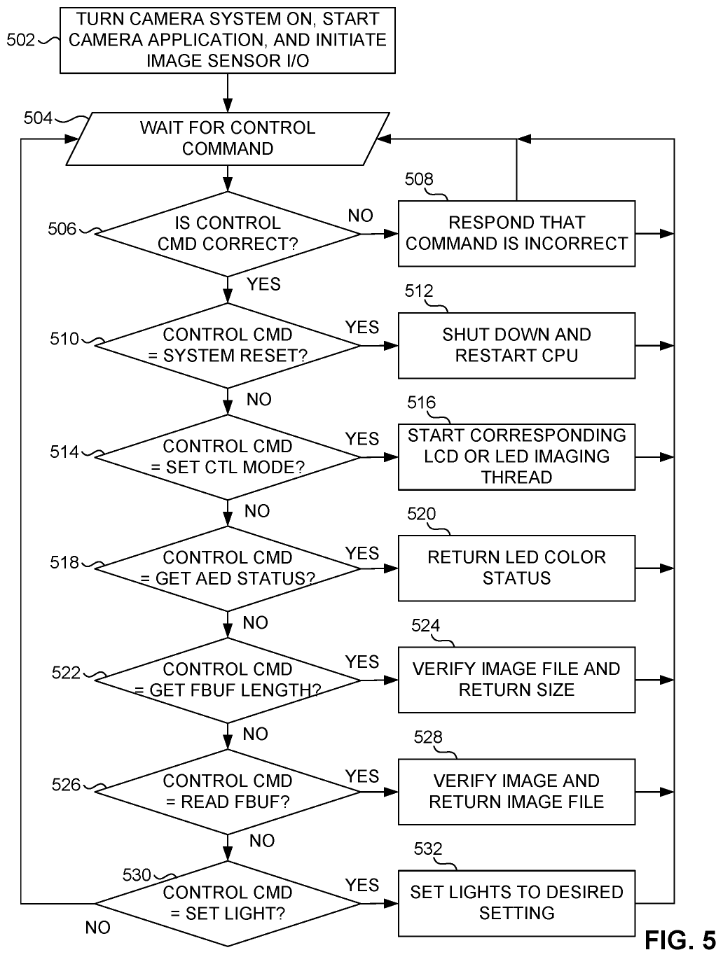

FIG. 5 is a flowchart of a method of operating a camera assembly of an electronic status monitoring system, consistent with an example embodiment. At 502, a signal such as from microcontroller of FIG. 3 may be received to wake the camera system from an off or sleep state, resulting in the camera assembly turning on and launching a camera application or thread. The camera application in a further example may be loaded into a memory 312 and executed in processor 310. An image sensor input/output process for the processor to communicate with camera 316 and optional with LED light 318 may also be started.

The camera application waits for a control command at 504, such as to take a digital image, return various information, handle errors, or otherwise perform various tasks. At 506, the camera application determines whether a received control command is a correct or valid command, and at 508 returns an incorrect command message if the command is not a valid or known command. At 510, the application determines whether the control command is a system reset command, and shuts down and restarts the camera processor 310 if the control command is a system reset command. At 514, the application determines whether the control command is a set control mode command, and starts a corresponding LCD imaging thread or LED imaging thread if the control command is a set control mode command.

At 518, the camera application determines whether the control command is a command to get AED status, and if the control command is a get AED status command returns an AED color status at 520. At 522, the camera application determines whether the control command is a get frame buffer length (GET FBUF LENGTH) command, and if so, verifies the size of an image file captured from the digital camera and returns the image size (such as dimensions in pixels, number of bytes of data, and/or the like) at 524. At 526, the camera application determines whether the received control command is a read frame buffer command (READ FBUF), and if so, verifies the image file and returns the buffered image file stored in memory 312 as shown at 528.

At 530, the camera application determines whether the control command is a set light command, and if so, sets lighting to the desired setting at 532. If not, the process returns to 504. The process then returns to 504 and waits for another control command, repeating the control command handling process for additional control commands received in the camera application.

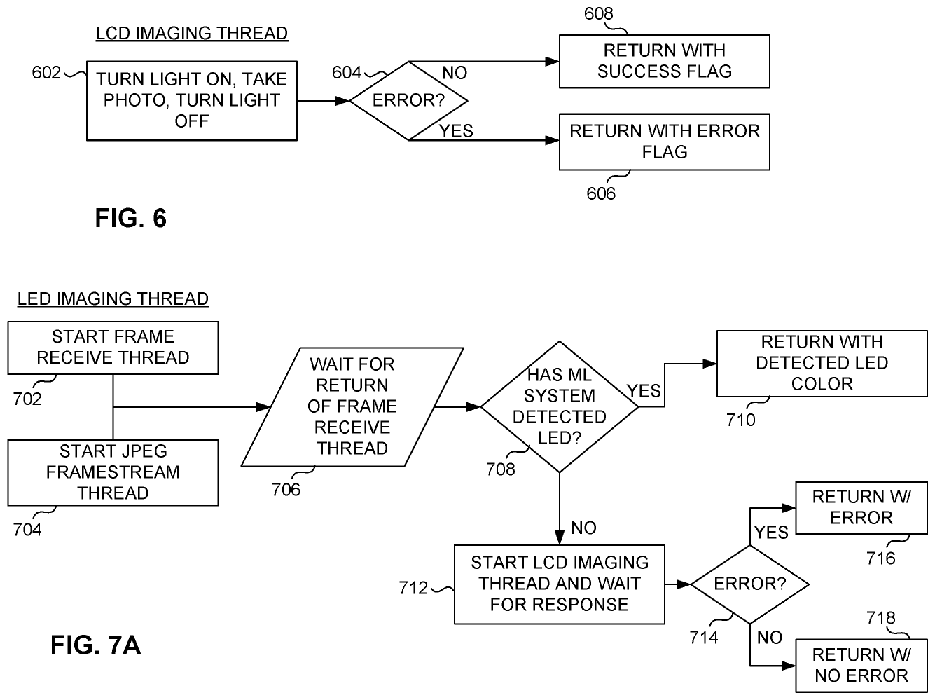

FIG. 6 is a flowchart of an LCD imaging thread, consistent with an example embodiment. The LCD imaging thread may be launched, for example, if the control command is determined at 514 of FIG. 5 to be a “set control mode” command setting the control mode to LCD imaging, resulting in launching an LCD imaging thread at 516. The LCD imaging threat at 602 may turn on a light, take a digital image or photograph, and turn off the light. At 604, an error handling process may determine whether an error was encountered in capturing an image of the AED or other electronic device, such as the light not turning on or the camera not returning a digital image. If an error was encountered, the process may return an error flag at 608, and may otherwise return a success flag at 608. In this example, the LCD imaging thread may store the captured digital image in an image buffer where it can be read by other processes or threads, but in other examples 608 may also include returning the digital image as part of the return message if the LCD digital imaging process was successful.

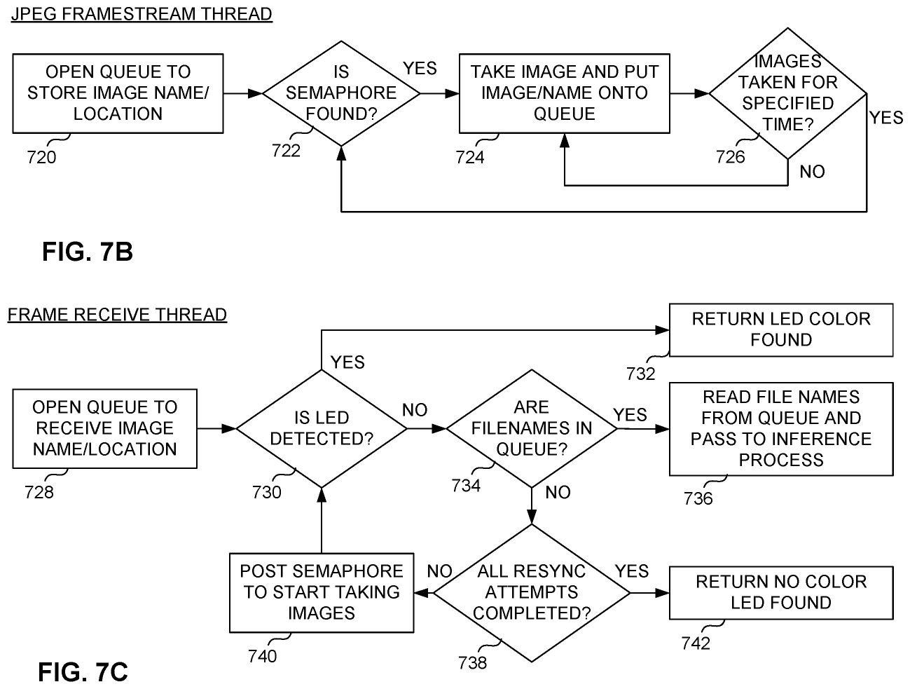

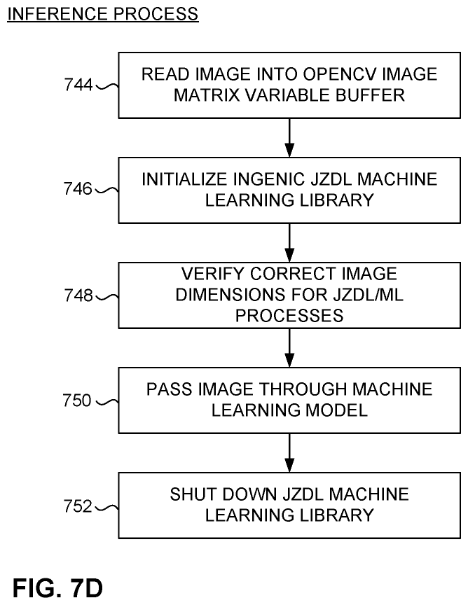

FIG. 7A is a flowchart of an LED imaging thread, consistent with an example embodiment. The LED imaging thread may be launched, for example, if the control command is determined at 514 of FIG. 5 to be a “set control mode” command setting the control mode to LED imaging, resulting in launching an LED imaging thread at 516. At 702, a frame receive thread is started, and at 704, a JPEG framestream thread is started. The JPEG framestream thread in a more detailed example may include responds to a semaphore by taking pictures for a specified time and placing the captured digital images onto a processing queue. The frame receive thread in a more detailed example processes incoming digital images to determine the LED color or LCD message, or other such visual status indicator.

At 706, the thread waits until the frame receive thread has returned a digital image, and at 708 the thread determines whether a machine learning system such as a neural network has evaluated the returned digital image and detected one or more LEDs. If an LED has been detected, the detected color of the LED is returned at 710. If the machine learning system does not detect an LED, an LCD imaging thread is started at 712, and the process waits for a response from the LCD imaging thread. If the response is an error as determined at 714, an error message is returned from the LED imaging thread at 716. If the response is not an error (such as successful completion of the LCD imaging), a response of no error is returned at 718. In this example, the LCD imaging thread may therefore be launched by the LED imaging thread if no LED is found, such that the process looks for an LED before attempting to analyze an image for an LCD or other graphic and/or text display content.

FIG. 7B is a flowchart of a JPEG framestream thread, consistent with an example embodiment. The JPEG framestream thread may be launched at 704 of FIG. 7A in some examples, and in this example is operable to capture digital images for a specified time and place them onto an image processing queue. At 720, a queue to store the capture digital image's name and location is opened. At 722, a process waits for a semaphore, and upon receipt of a semaphore proceeds to 724 to take a digital image and place the image and name onto the opened image processing queue. At 726, a process determines whether images have been taken for a specified time, and continues taking digital images at 724 until the specified time has elapsed. If the specified time has elapsed at 726, the process returns to 722 and waits for another semaphore to capture another sequence of images for a specified time.

FIG. 7C is a flowchart of a frame receive thread, consistent with an example embodiment. The frame receive thread may be launched at 702 of FIG. 7A in some examples, and in this example evaluates images received from an image queue to determine the state of an LED or LCD in the captured image or images. At 728, the image queue is opened to receive images along with their associated name and location data. At 730, a process determines whether the camera processor's neural network or a similar process has detected an LED in the image. If an LED was detected, the color of the LED is returned at 732. If no LED was found, the process proceeds to 734, where the queue is evaluated to determine if there are additional filenames in the queue. If there are filenames in the queue, the filenames (representing the digital images) are passed to an inference process at 736. If there are no filenames in the queue, the process proceeds to 738 where it determines whether all resync attempts to capture and process images have been completed. If all resync attempts have not been completed, a semaphore to start taking pictures is issued at 740, and the process returns to 730 to monitor incoming images for the presence of an LED. In a more detailed example, the semaphore sent at 740 is received at 722 of the JPEG framestream thread shown in FIG. 7B to initiate taking another sequence of images. If all resync attempts have been completed, the process returns a “no color LED found” message at 742.

FIG. 7D is a flowchart of an inference process, consistent with an example embodiment. The inference process described here may be initiated by receiving a passed filename, image, or the like from a frame receive thread such as that of FIG. 7C, as shown at 736. At 744, the inference process reads an image, such as into OpenCV or STB, which are open source computer vision libraries. In a further example, the computer vision library may be employed to process the image, such as to resize, adjust brightness and/or contrast, or perform other such image processing. A machine learning library is loaded at 746, such as the JZDL inference machine learning library for Ingenic processors, which in a further example may comprise a neural network configured to evaluate and/or classify an image, such as a convolutional neural network. In other examples, other processors, machine learning libraries, image processing libraries, and the like may be employed. The image dimensions in the example of FIG. 7 are confirmed at 748 to be appropriate for the machine learning model in JZDL, and in a further example is resized by JZDL if the size is incorrect. The image may then be passed through the machine learning model in JZDL at 750, producing an output that is returned to the process calling the inference process. The JDZL machine learning library is then shut down at 752, and the inference process is complete. Other embodiments employing other machine learning libraries, processors, or other such components, may employ some, all, or none of these steps in performing similar machine learning classification functions.

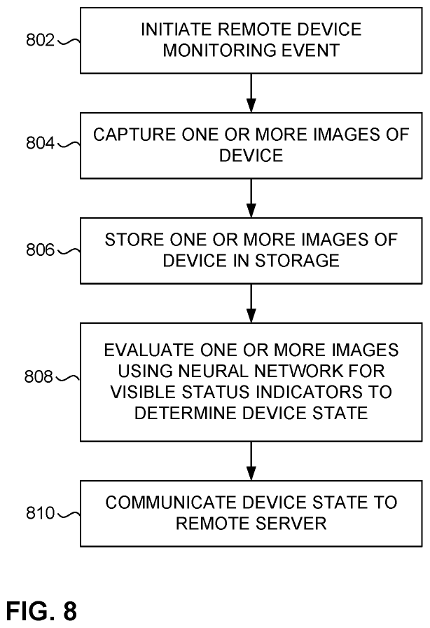

FIG. 8 is a flowchart of a method of operating an electronic status detection system, consistent with an example embodiment. At 802, a remote device monitoring event is triggered, such as by passage of time, manual triggering, or an event such as an AED cabinet door or case lid opening. The monitoring event causes the electronic status detection system to capture one or more images of the device being monitored, such as an AED in an AED cabinet or case, at 804. The one or more captured images are stored in a storage such as memory, flash memory, hard disk drive, or the like at 806, and queued for processing. At 808, the electronic monitoring system evaluates the one or more images using a machine learning tool such as a neural network for visible status indicators to determine the device state, and the determined device state is communicated to a remote server at 810.

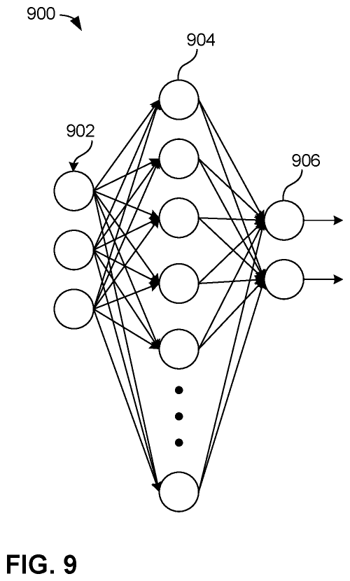

The machine learning system employed in various examples presented herein may comprise any type of machine learning or artificial intelligence, but in some detailed examples will comprise a neural network such as a convolutional neural network. FIG. 9 is a schematic diagram of a neural network 900 formed in “layers” in which an initial layer is formed by nodes 902 and a final layer is formed by nodes 906. All or a portion of features of neural network 900 may be implemented various embodiments of systems described herein. Neural network 900 may include one or more intermediate layers, shown here by intermediate layer of nodes 904. Edges shown between nodes 902 and 904 illustrate signal flow from an initial layer to an intermediate layer. Likewise, edges shown between nodes 904 and 906 illustrate signal flow from an intermediate layer to a final layer. While neural network 900 shows a single intermediate layer formed by nodes 904, other implementations of a neural network may include multiple intermediate layers formed between an initial layer and a final layer.

In one example, a node 902, 904 and/or 906 may process input signals (e.g., received on one or more incoming edges) to provide output signals (e.g., on one or more outgoing edges) according to an activation function. An “activation function” as referred to herein means a set of one or more operations associated with a node of a neural network to map one or more input signals to one or more output signals. In a particular implementation, such an activation function may be defined based, at least in part, on a weight associated with a node of a neural network. Operations of an activation function to map one or more input signals to one or more output signals may comprise, for example, identity, binary step, logistic (e.g., sigmoid and/or soft step), hyperbolic tangent, rectified linear unit, Gaussian error linear unit, Softplus, exponential linear unit, scaled exponential linear unit, leaky rectified linear unit, parametric rectified linear unit, sigmoid linear unit, Swish, Mish, Gaussian and/or growing cosine unit operations. Operations such as these may be applied to map input signals of a node to output signals in an activation function, but other examples may employ other such activation functions or operations.

An “activation input value” as referred to herein means a value provided as an input parameter and/or signal to an activation function defined and/or represented by a node in a neural network. Likewise, an “activation output value” as referred to herein means an output value provided by an activation function defined and/or represented by a node of a neural network. In one example, an activation output value may be computed and/or generated according to an activation function based on and/or responsive to one or more activation input values received at a node. In some examples, an activation input value and/or activation output value may be structured, dimensioned and/or formatted as “tensors”. An “activation input tensor” as referred to herein therefore means an expression of one or more activation input values according to a particular structure, dimension and/or format. Likewise in this context, an “activation output tensor” as referred to herein means an expression of one or more activation output values according to a particular structure, dimension and/or format.

In some examples, neural networks may enable improved results in a wide range of tasks, including image recognition, speech recognition, or other such applications. To enable performing such tasks, features of a neural network (e.g., nodes, edges, weights, layers of nodes and edges) may be structured and/or configured to form “filters” that may have a measurable/numerical state such as a value of an output signal. Such a filter may comprise nodes and/or edges arranged in “paths” and are to be responsive to sensor observations provided as input signals. In some examples, a state and/or output signal of such a filter may indicate and/or infer detection of a presence or absence of a feature in an input signal.

In some examples, a neural network may be structured in layers such that a node in a particular neural network layer may receive output signals from one or more nodes in an upstream layer in the neural network, and provide an output signal to one or more nodes in a downstream layer in the neural network. One specific class of layered neural networks may comprise a convolutional neural network (CNN) or space invariant artificial neural networks (SIANN) that enable deep learning. Such CNNs and/or SIANNs may be based, at least in part, on a shared-weight architecture of a convolution kernels that shift over input features and provide translation equivariant responses. Such CNNs and/or SIANNs may be applied to image and/or video recognition, recommender systems, image classification, image segmentation, medical image analysis, natural language processing, brain-computer interfaces, financial time series, just to provide a few examples.

Another class of layered neural network may comprise a recursive neural network (RNN) that is a class of neural networks in which connections between nodes form a directed cyclic graph along a temporal sequence. Such a temporal sequence may enable modeling of temporal dynamic behavior. In an implementation, an RNN may employ an internal state (e.g., memory) to process variable length sequences of inputs. This may be applied, for example, to tasks such as unsegmented, connected handwriting recognition or text recognition, just to provide a few examples. In particular implementations, an RNN may emulate temporal behavior using finite impulse response (FIR) or infinite impulse response (IIR) structures. An RNN may include additional structures to control stored states of such FIR and IIR structures to be aged. Structures to control such stored states may include a network or graph that incorporates time delays and/or has feedback loops, such as in long short-term memory networks (LSTMs) and gated recurrent units.

In some examples, output signals of one or more neural networks (e.g., taken individually or in combination) may at least in part, define a “predictor” to generate prediction values associated with some observable and/or measurable phenomenon and/or state. In an implementation, a neural network may be “trained” to provide a predictor that is capable of generating such prediction values based on input values (e.g., measurements and/or observations) optimized according to a loss function. For example, a training process may employ backpropagation techniques to iteratively update neural network weights to be associated with nodes and/or edges of a neural network based, at least in part on “training sets.” Such training sets may include training measurements and/or observations to be supplied as input values that are paired with “ground truth” observations or expected outputs, such as images of an electronic device having one or more visible status indicators and the associated known status of the device. Based on a comparison of such ground truth observations and associated prediction values generated based on such input values in a training process, weights may be updated according to a loss function using backpropagation.

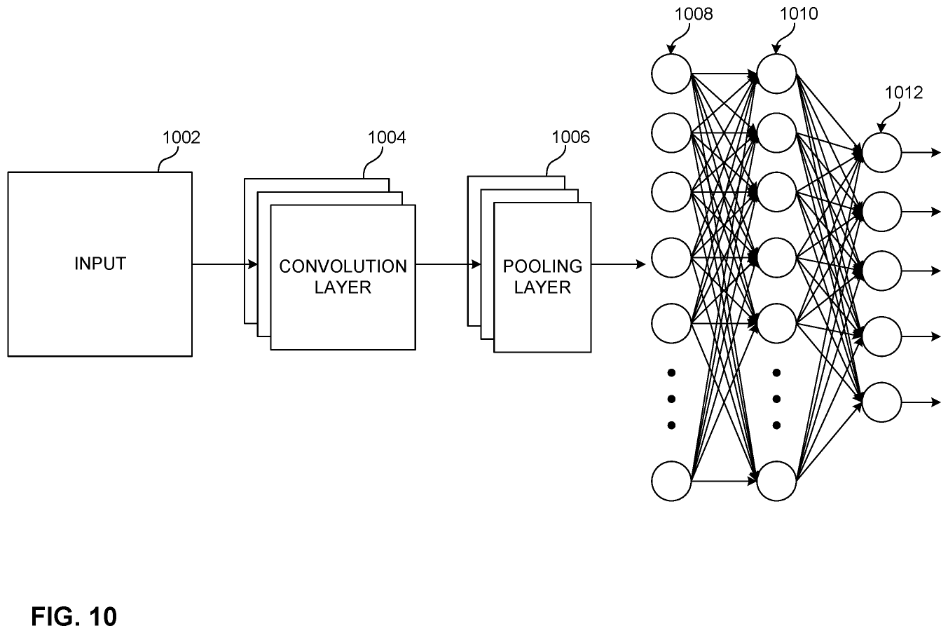

The neural networks employed in various examples can be any known or future neural network architecture, including traditional feed-forward neural networks, convolutional neural networks, or other such networks. FIG. 10 shows a convolutional neural network, including a fully-connected feed-forward section configured to classify an input, consistent with an example embodiment. A convolutional neural network is configured to recognize the importance of information in one input region relative to inputs in other input regions, such as the pixels around an object being filtered rather than pixels in a remote part of the image. Because spatial and temporal relatedness are built in to various convolutional neural network configurations, the convolutional neural network does not have to learn the importance of this relatedness as it would in a simple flattened backpropagation neural network and is more efficient.

FIG. 10 shows a convolutional neural network as may be used to determine an electronic device status from an image in some example embodiments. In FIG. 10, the input 1002 comprises an image which in this example is a 640×640 image in an RGB color space, having pixel locations arranged in a two-dimensional grid with three channels of color intensity or brightness (one channel each for red, green, and blue light). When performing image processing functions such as object recognition, sharpening, or the like, pixels immediately surrounding an image area being processed are most relevant to determining an output, as are pixels in corresponding locations in each of the three color channels.

Convolution layer 1004 comprises a kernel value derived from the image for the kernel region surrounding pixels in the original image, such as using a kernel filter of nine pixels configured to include each original pixel as well as the eight pixels surrounding the original pixel in a 3×3 matrix. As the kernel filter is swept across the original image, an element-wise multiplication of the kernel filter and the image values is performed for each location, and a sum of each element in the product matrix is stored in the convolution layer 1004. The kernel filter in some examples will weight each element equally, such as by having ones as multipliers in each element of the 3×3 kernel filter, but in other examples will weight elements differently by having different multipliers for different elements. Because the original image provided as an input at 1002 is 640×640 and it is swept by a kernel filter of 3×3 that does not sweep outside the bounds of the original image, the output stored in convolution layer 1004 is a matrix of size 638×638 in three channels. In another example, the original image is padded on all sides with a value such as zeros or with repeated border values to increase the input size to 642×642 before sweeping with the 3×3 kernel filter, resulting in an output stored in convolution layer 1004 of 640×640 (the original input size). In some alternate examples, the three channels representing red, blue, and green colors are combined in a single channel, or in a fourth channel in addition to the three color channels.

Pooling layer 1006 is configured to reduce the spatial size of the convolved features in convolution layer 1004, which provides the benefit of reducing the computational power required to process the data. Pooling again involves sweeping the prior data structure with a kernel to produce a new data structure, such as sweeping the convolution layer matrix 1004 with a 3×3 kernel. Common pooling algorithms include max pooling, in which the maximum value in the 3×3 kernel or window sweeping the convolution layer is recorded for each windowed location in the convolution layer, and average pooling, in which the average value in the 3×3 kernel sweeping the convolution layer is recorded for each swept location. Max pooling removes noise from data well, and is often preferred over average pooling in which dimensionality reduction is the primary effect.

The kernel in the pooling step in some examples is of different size than the kernel in the convolution layer step, and in another example strides or sweeps across the input data matrix by more than one element at a time. In one such example a 2×2 kernel is used in the pooling step, with a stride of two in each dimension, such that each data element in the convolution layer contributes to only one element in the pooling layer which is approximately one-fourth the size of the convolution layer. In further examples, one or more additional layers or variations on the convolution layer and/or the pooling layer are employed, and may be beneficial to reducing the computational power needed to recognize various elements or features in the input data 1002. For example, the convolution and pooling layers may be repeated to further reduce the input data before further processing.

The pooling layer 1006 is then flattened in flattened layer 1008, for processing in a traditional feed-forward neural network comprising one or more intermediate layers as shown at 1010. In a more detailed example, the feed-forward layers are fully connected, meaning each node in an intermediate layer is connected to each node in preceding and subsequent layers, and uses a nonlinear activation function such as the ReLU (rectified linear) or similar activation function.

The output 1012 in the example of FIG. 6 comprises a soft-max activation function, in which the input image at 1002 is classified as being one of five different possible outputs, such as one of five possible operating states. In a more detailed example, operating states of normal, battery low, electrode pad expired, device error, or no visible status indicator detected correspond to the five possible outputs of the convolutional neural network at 1012, and the output with the highest value is the determined status of the AED or other electronic device.

The convolutional neural network's input, output, and intermediate data sets are often referred to as “tensors”, which can have multiple dimensions or “ranks” depending on the data type, dimensionality, and number of channels in the data set. Vectors within a tensor represent related data elements, such as data set of 100 stocks having 365 daily closing prices in which 100 vectors of 365 elements each are stored in a 100×365 tensor denoted as (100,365). Complex data such as video may have many dimensions of related data, such as where a two-dimensional image of 1920×1080 plus color depth of 256 plus frame number in the video sequence of 10,000 comprise a four dimensional tensor (10000,1920,1080,256). Examples such as these illustrate the benefit of feature recognition and data reduction in a convolutional neural network before processing in a feed-forward neural network to make efficient use of processing power.

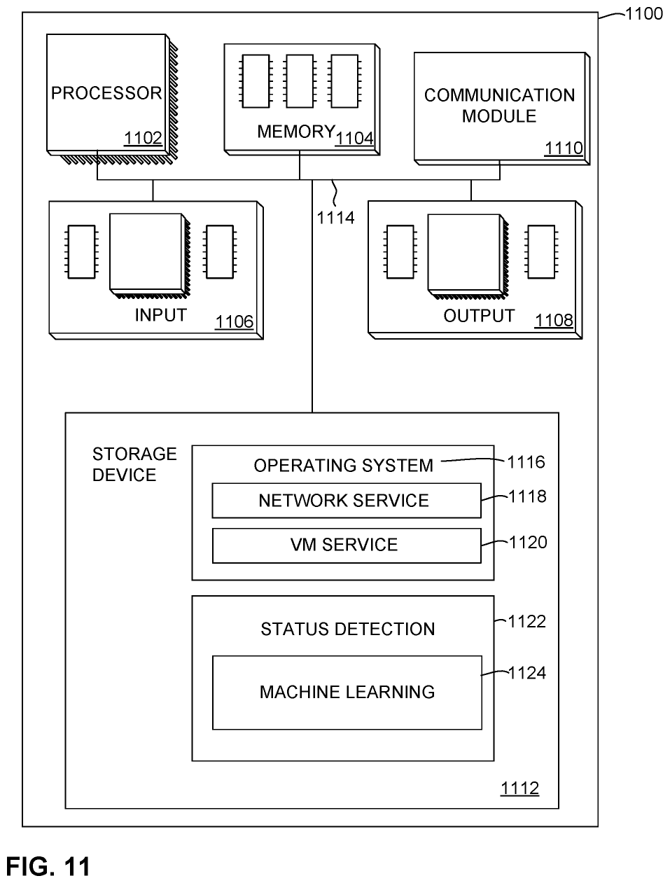

FIG. 11 shows a computing environment in which one or more electronic status monitoring functions may be implemented, consistent with an example embodiment. FIG. 11 illustrates only one particular example of computing device 1100, and other computing devices 1100 may be used in other embodiments. Although computing device 1100 is shown as a standalone computing device, computing device 1100 may be any component or system that includes one or more processors or another suitable computing environment for executing software instructions in other examples, and need not include all of the elements shown here.

As shown in the specific example of FIG. 11, computing device 1100 includes one or more processors 1102, memory 1104, one or more input devices 1106, one or more output devices 1108, one or more communication modules 1110, and one or more storage devices 1112. Computing device 1100, in one example, further includes an operating system 1116 executable by computing device 1100. The operating system includes in various examples services such as a network service 1118 and a virtual machine service 1120 such as a virtual server. One or more applications, such as status detection application 1122 are also stored on storage device 1112, and are executable by computing device 1100.

Each of components 1102, 1104, 1106, 1108, 1110, and 1112 may be interconnected (physically, communicatively, and/or operatively) for inter-component communications, such as via one or more communications channels 1114. In some examples, communication channels 1114 include a system bus, network connection, inter-processor communication network, or any other channel for communicating data. Applications such as status detection application 1122 and operating system 1116 may also communicate information with one another as well as with other components in computing device 1100.

Processors 1102, in one example, are configured to implement functionality and/or process instructions for execution within computing device 1100. For example, processors 1102 may be capable of processing instructions stored in storage device 1112 or memory 1104. Examples of processors 1102 include any one or more of a microprocessor, a controller, a central processing unit (CPU), a graphics processing unit (GPU), a neural processing unit (NPU), an image signal processor (ISP), a digital signal processor (DSP), an application specific integrated circuit (ASIC), a field-programmable gate array (FPGA), or similar discrete or integrated logic circuitry.

One or more storage devices 1112 may be configured to store information within computing device 1100 during operation. Storage device 1112, in some examples, is known as a computer-readable storage medium. In some examples, storage device 1112 comprises temporary memory, meaning that a primary purpose of storage device 1112 is not long-term storage. Storage device 1112 in some examples is a volatile memory, meaning that storage device 1112 does not maintain stored contents when computing device 1100 is turned off. In other examples, data is loaded from storage device 1112 into memory 1104 during operation. Examples of volatile memories include random access memories (RAM), dynamic random access memories (DRAM), static random access memories (SRAM), and other forms of volatile memories known in the art. In some examples, storage device 1112 is used to store program instructions for execution by processors 1102. Storage device 1112 and memory 1104, in various examples, are used by software or applications running on computing device 1100 such as status detection application 1122 to temporarily store information during program execution.

Storage device 1112, in some examples, includes one or more computer-readable storage media that may be configured to store larger amounts of information than volatile memory. Storage device 1112 may further be configured for long-term storage of information. In some examples, storage devices 1112 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 1100, in some examples, also includes one or more communication modules 1110. Computing device 1100 in one example uses communication module 1110 to communicate with external devices via one or more networks, such as one or more wireless networks. Communication module 1110 may be a network interface card, such as an Ethernet card, an optical transceiver, a radio frequency transceiver, or any other type of device that can send and/or receive information. Other examples of such network interfaces include Bluetooth, 4G, LTE, or 5G, WiFi radios, and Near-Field Communications (NFC), and Universal Serial Bus (USB). In some examples, computing device 1100 uses communication module 1110 to wirelessly communicate with an external device such as via public network 118 of FIG. 1.

Computing device 1100 also includes in one example one or more input devices 1106. Input device 1106, in some examples, is configured to receive input from a user through tactile, audio, or video input. Examples of input device 1106 include a touchscreen display, a mouse, a keyboard, a voice responsive system, video camera, microphone or any other type of device for detecting input from a user.

One or more output devices 1108 may also be included in computing device 1100. Output device 1108, in some examples, is configured to provide output to a user using tactile, audio, or video stimuli. Output device 1108, in one example, includes a display, a sound card, a video graphics adapter card, or any other type of device for converting a signal into an appropriate form understandable to humans or machines. Additional examples of output device 1108 include a speaker, a light-emitting diode (LED) display, a liquid crystal display (LCD or OLED), or any other type of device that can generate output to a user.

Computing device 1100 may include operating system 1116. Operating system 1116, in some examples, controls the operation of components of computing device 1100, and provides an interface from various applications such as status detection application 1122 to components of computing device 1100. For example, operating system 1116, in one example, facilitates the communication of various applications such as status detection application 1122 with processors 1102, communication unit 1110, storage device 1112, input device 1106, and output device 1108. Applications such as status detection application 1122 may include program instructions and/or data that are executable by computing device 1100. As one example, status detection application 1122 may implement a trained machine learning element 1124 to perform status detection based on an image of an electronic device such as an AED being monitored such as described above. These and other program instructions or modules may include instructions that cause computing device 1100 to perform one or more of the other operations and actions described in the examples presented herein.

Although specific embodiments have been illustrated and described herein, any arrangement that achieve the same purpose, structure, or function may be substituted for the specific embodiments shown. This application is intended to cover any adaptations or variations of the example embodiments of the invention described herein. These and other embodiments are within the scope of the following claims and their equivalents.

Features of example computing devices described herein may comprise features, for example, of a client computing device and/or a server computing device, in an embodiment. It is further noted that the term computing device, in general, whether employed as a client and/or as a server, or otherwise, refers at least to a processor and a memory connected by a communication bus. A “processor” and/or “processing circuit” for example, is understood to connote a specific structure such as a central processing unit (CPU), digital signal processor (DSP), graphics processing unit (GPU), image signal processor (ISP) and/or neural processing unit (NPU), or a combination thereof, of a computing device which may include a control unit and an execution unit. In an aspect, a processor and/or processing circuit may comprise a device that fetches, interprets and executes instructions to process input signals to provide output signals. As such, in the context of the present patent application at least, this is understood to refer to sufficient structure within the meaning of 35 USC § 112 (f) so that it is specifically intended that 35 USC § 112 (f) not be implicated by use of the term “computing device,” “processor,” “processing unit,” “processing circuit” and/or similar terms; however, if it is determined, for some reason not immediately apparent, that the foregoing understanding cannot stand and that 35 USC § 112 (f), therefore, necessarily is implicated by the use of the term “computing device” and/or similar terms, then, it is intended, pursuant to that statutory section, that corresponding structure, material and/or acts for performing one or more functions be understood and be interpreted to be described at least in FIG. 11 and in the text associated with the foregoing figure(s) of the present patent application.

The term electronic file and/or the term electronic document, as applied herein, refer to a set of stored memory states and/or a set of physical signals associated in a manner so as to thereby at least logically form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

In the context of the present patent application, the terms “entry,” “electronic entry,” “document,” “electronic document,” “content,”, “digital content,” “item,” and/or similar terms are meant to refer to signals and/or states in a physical format, such as a digital signal and/or digital state format, e.g., that may be perceived by a user if displayed, played, tactilely generated, etc. and/or otherwise executed by a device, such as a digital device, including, for example, a computing device, but otherwise might not necessarily be readily perceivable by humans (e.g., if in a digital format).

Also, for one or more embodiments, an electronic document and/or electronic file may comprise a number of components. As previously indicated, in the context of the present patent application, a component is physical, but is not necessarily tangible. As an example, components with reference to an electronic document and/or electronic file, in one or more embodiments, may comprise text, for example, in the form of physical signals and/or physical states (e.g., capable of being physically displayed). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed). In an embodiment, digital content may comprise, for example, text, images, audio, video, and/or other types of electronic documents and/or electronic files, including portions thereof, for example.

Also, in the context of the present patent application, the term “parameters” (e.g., one or more parameters), “values” (e.g., one or more values), “symbols” (e.g., one or more symbols) “bits” (e.g., one or more bits), “elements” (e.g., one or more elements), “characters” (e.g., one or more characters), “numbers” (e.g., one or more numbers), “numerals” (e.g., one or more numerals) or “measurements” (e.g., one or more measurements) refer to material descriptive of a collection of signals, such as in one or more electronic documents and/or electronic files, and exist in the form of physical signals and/or physical states, such as memory states. For example, one or more parameters, values, symbols, bits, elements, characters, numbers, numerals or measurements, such as referring to one or more aspects of an electronic document and/or an electronic file comprising an image, may include, as examples, time of day at which an image was captured, latitude and longitude of an image capture device, such as a camera, for example, etc. In another example, one or more parameters, values, symbols, bits, elements, characters, numbers, numerals or measurements, relevant to digital content, such as digital content comprising a technical article, as an example, may include one or more authors, for example. Claimed subject matter is intended to embrace meaningful, descriptive parameters, values, symbols, bits, elements, characters, numbers, numerals or measurements in any format, so long as the one or more parameters, values, symbols, bits, elements, characters, numbers, numerals or measurements comprise physical signals and/or states, which may include, as parameter, value, symbol bits, elements, characters, numbers, numerals or measurements examples, collection name (e.g., electronic file and/or electronic document identifier name), technique of creation, purpose of creation, time and date of creation, logical path if stored, coding formats (e.g., type of computer instructions, such as a markup language) and/or standards and/or specifications used so as to be protocol compliant (e.g., meaning substantially compliant and/or substantially compatible) for one or more uses, and so forth.

What is claimed is:

1. A computer-implemented method of training a neural network for detection of a status of an electronic device, the method comprising:
collecting a training set of digital images of at least one electronic device from a data set, the digital images comprising images having at least one visible electronic indicator of the at least one electronic device; and
training the neural network using the collected training set of digital images of the at least one electronic device, such that the trained neural network is operable to evaluate one or more additional digital images of the at least one electronic device via the at least one visible electronic indicator to determine the status of the at least one electronic device.

2. The computer-implemented method of claim 1, wherein the one or more additional digital images comprise an associated data record indicating a current state of the at least one visible electronic indicator of the at least one electronic device.

3. The computer-implemented method of claim 1, wherein the neural network comprises a convolutional neural network.

4. The computer-implemented method of claim 1, wherein the at least one electronic device comprises an Automated External Defibrillator (AED).

5. The computer-implemented method of claim 1, wherein the at least one visible electronic indicator comprises at least one of the following: a Liquid Crystal Display (LCD) image; an Organic Light Emitting Diode (OLED) display image; an electronic display image; or any combination thereof.

6. The computer-implemented method of claim 1, wherein the at least one visible electronic indicator comprises at least one of the following: a Light-Emitting Diode (LED) color; an on/off state; a blinking state; or any combination thereof.

7. A computer-implemented method of electronically determining a status of a device on a communications network using one or more artificial intelligence processes, the method comprising:
electronically capturing one or more images of the device via an imaging sensor of a camera;
selectively storing the one or more captured images of the device in memory for processing;
evaluating, using the one or more artificial intelligence processes trained on a data set comprising the one or more captured images of the device, the one or more captured images of the device for one or more visible electronic indicators of a state thereof to determine the status of the device; and
communicating the status of the device to one or more electronic devices via the communications network.

8. The method of claim 7, wherein the one or more visible electronic indicators of the state comprises: a Liquid Crystal Display (LCD) image; an Organic Light Emitting Diode (OLED) display image; and/or another electronic display image.

9. The method of claim 7, wherein the one or more visible electronic indicators of the state comprises: a Light-Emitting Diode (LED) color; an on/off state; and/or a blinking state.

10. The method of claim 9, wherein electronically capturing the one or more images of the device comprises electronically capturing a plurality of images and/or a video sequence of images, and the one or more visible electronic indicators of the state comprises a blinking state of one or more LEDs determined by evaluating the plurality of images and/or the video sequence of images.

11. The method of claim 7, wherein the one or more artificial intelligence processes include utilizing a neural network.

12. The method of claim 11, wherein the neural network comprises a convolutional neural network.

13. The method of claim 7, wherein the capturing one or more images is triggered in part by at least one of the following: a period of time passing; a user-initiated trigger; a calendar-based trigger; or any combination thereof.

14. The method of claim 7, wherein the determined status comprises at least one of the following: an operational status; an error; an error condition; a configuration; an expired element; a to-be-expired element; or any combination thereof.

15. The method of claim 7, wherein the communications network comprises a wireless cellular communications network.

16. The method of claim 15, wherein the wireless cellular communications network comprises one or more of enhanced machine-type communication (eMTC), eMTC category M1 (Cat-M1), NB-IoT, LTE, and/or 5G.

17. The method of claim 7, wherein the device comprises an Automated External Defibrillator (AED).

18. The method of claim 7, wherein the one or more images comprise a video sequence.

19. A computer-implemented method of remotely monitoring a state of a device using an artificial intelligence process, the method comprising:
capturing one or more digital images of the device via a digital camera;
storing the one or more digital images of the device in memory;
communicating the one or more captured images of the device to a remote server; and
evaluating, on the remote server, using the artificial intelligence process trained on a data set comprising the one or more digital images of the device, the one or more digital images of the device for one or more visible electronic indicators to determine the state of the device.

20. The method of claim 19, wherein the one or more visible electronic comprises a Liquid Crystal Display (LCD) image, an Organic Light Emitting Diode (OLED) display image, or a Light-Emitting Diode (LED) color, on/off state, or blinking state.

21. The method of claim 19, wherein capturing one or more digital images of the device comprises electronically taking a plurality of images or a video sequence of images, and the one or more visible electronic indicators comprises a blinking state of one or more Light-Emitting Diodes (LEDs) determined by evaluating the plurality of images or video sequence of images.

22. The method of claim 19, wherein the artificial intelligence process comprises a neural network process.

23. The method of claim 19, wherein capturing the one or more digital images is triggered by a period of time passing, a user-initiated trigger, and/or a calendar-based trigger.

24. The method of claim 19, the determined state comprising at least one of the following: an operational state; an error; an error condition; a configuration; an expired element; a to-be-expired element; or any combination thereof.

25. The method of claim 19, wherein communicating comprises using at least one of: wireless cellular communication, enhanced machine-type communication (eMTC), eMTC category M1 (Cat-M1), NB-IoT, LTE, and/or 5G.

26. The method of claim 19, wherein the device comprises an Automated External Defibrillator (AED).

27. An apparatus comprising a computerized device for monitoring a status of a remote device using an artificial intelligence process, comprising:
at least one computing device comprising at least one processor and at least one memory, the at least one computing device operable to execute computer instructions fetched from the at least one memory on the at least one processor and to store results of executing the computer instructions in the at least one memory, the executed computer instructions operable to cause the at least one computing device to:
capture one or more images of the remote device being remotely monitored with a camera process;
store the one or more images of the remote device in the at least one memory;
evaluate, using the artificial intelligence process trained on a data set comprising the one or more images of the remote device, the one or more images of the device for one or more visible electronic indicators of a state of the one or more visible electronic indicators to determine the status of the device; and
communicate the determined status of the remote device to one or more additional computing devices.

28. The apparatus of claim 27, wherein the one or more visible electronic indicators comprises at least one of the following: a Liquid Crystal Display (LCD) image; an Organic Light Emitting Diode (OLED) display image; a Light-Emitting Diode (LED) color; an on/off state; a blinking state; or any combination thereof.

29. The apparatus of claim 27, wherein capturing the one or more images of the device comprises electronically taking a plurality of images or a video sequence of images, and the one or more visible electronic indicators comprises a blinking state of one or more Light-Emitting Diodes (LEDs) determined by evaluating the plurality of images or video sequence of images.

30. The apparatus of claim 27, wherein the artificial intelligence process implements a neural network, at least in part.

31. The apparatus of claim 27, wherein capturing the one or more images is triggered by a period of time passing, a user-initiated trigger, and/or calendar-based trigger.

32. The apparatus of claim 27, wherein the determined state comprises at least one of: an operational state; an error; an error condition; a configuration; an expired element; and/or a to-be-expired element.

33. The apparatus of claim 27, wherein to communicate comprises utilization of at least one of wireless cellular communication, enhanced machine-type communication (eMTC), eMTC category M1 (Cat-M1), NB-IoT, LTE, and/or 5G.

34. The apparatus of claim 27, wherein the remote device comprises an Automated External Defibrillator (AED).

35. An apparatus comprising a computerized device for monitoring a status of a remote device via an application of artificial intelligence, the method comprising:
at least one computing device comprising at least one processor and at least one memory, the at least one computing device operable to execute computer instructions fetched from the at least one memory on the at least one processor and to store results of executing the computer instructions in the at least one memory, the computer instructions operable when executed to cause the at least one computing device to:
capture one or more images of the device being remotely monitored with a camera;
store the one or more images of the device in the at least one memory;
communicate the one or more images of the device to a server device; and
evaluate, via the server device and using the artificial intelligence trained on a data set comprising images of the device, the one or more images of the device for one or more visible electronic indicators of a state thereof to determine the status of the device.

36. The apparatus of claim 35, wherein the one or more visible electronic indicators comprises: a Liquid Crystal Display (LCD) image, an Organic Light Emitting Diode (OLED) display image, and/or a Light-Emitting Diode (LED) color, on/off state, or blinking state.

37. The apparatus of claim 35, wherein to capture the one or more images of the device comprises electronically taking a plurality of images or a video sequence of images, and the one or more visible electronic indicators comprises a blinking state of one or more Light-Emitting Diodes (LEDs) determined by evaluating the plurality of images or video sequence of images.

38. The apparatus of claim 35, wherein the artificial intelligence comprises a neural network.

39. The apparatus of claim 35, wherein to capture the one or more images is to be triggered by a period of time passing, a user-initiated trigger, and/or a calendar-based trigger.

40. The apparatus of claim 35, wherein the determined state comprises at least one of the following: an operational state; an error; an error condition; a configuration; an expired element; a to-be-expired element; or any combination thereof.

41. The apparatus of claim 35, wherein the one or more images are to be communicated via at least one of; wireless cellular communication, enhanced machine-type communication (eMTC), eMTC category M1 (Cat-M1), NB-IoT, LTE, and/or 5G.

42. The apparatus of claim 35, wherein the remote device comprises an Automated External Defibrillator (AED).
